(19) United States
(12) Patent Application Publication
(10) Pub. No.: US 2006/0278109 A1
(43) Pub. Date: Dec. 14, 2006

(54) Process and method of manufacture for affixing lenticular artwork to a cloth surface

(76) Inventors: Kent Christian Johnson, Newport Coast, CA (US); Stephen Burnett, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/398,444

(22) Filed: Apr. 5, 2006

Related U.S. Application Data
(60) Provisional application No. 60/668,853, filed on Apr. 6, 2005.

(51) Int. Cl. B41F 1/28

(52) U.S. Cl. 101/415.1

(57) ABSTRACT

The present invention covers apparel items and softgoods having a lenticular image piece and methods for attaching the piece to such items. A lenticular piece is attached to cloth material by a process of RF welding. The piece is produced from a polymer that is rigid yet able to be RF welded. The piece is then welded to the item by a RF welding die having at least one raised welding edge. Another embodiment includes placing flexible polymer films between the item and the piece and on top of the piece. In one embodiment, the welding die includes an inner welding edge and an outer welding edge and the piece is die-cut so that the diameter of the piece is greater than that of the inner edge but less than that of the outer edge.

### CROSS-REFERENCE TO RELATED APPLICATIONS

The following patent application claims priority to U.S. Provisional Application No. 60/668,853 filed on Apr. 6, 2005, the disclosure of which is expressly incorporated herein by reference.

### STATEMENT RE: FEDERALLY SPONSORED RESEARCH/DEVELOPMENT

Not Applicable

### BACKGROUND

1. Field of the Invention

The present invention relates to a process for attaching lenticular graphics to wearing apparel and other soft goods. More particularly, the present invention provides a method for fusing the edges of a lenticular polymer onto a fabric surface using RF welding.

2. Background Art

Lenticular printing and lenticular lenses are widely adapted for use on or with a variety of items such as signs, posters, collectibles, coasters, magnets, postcards and business cards. Lenticular technology is also used in packaging, publishing, and labeling. Lenticular technology is particularly eye catching and draws attention to what are otherwise two-dimensional graphics.

Lenticular images provide an illusory effect of movement and three-dimensional depth. The effect is created by the combination of lenticular lenses (a series of lenticules) and an underlying interlaced image. Lenticules are typically formed uniformly across the surface of a translucent plastic substrate. The interlaced image is a computer generated segmented image and is written on the undersurface of the plastic substrate. In use, a viewer looks through the lenticular lenses and an image is assembled from the segmented interlaced images thereby creating a single image which has depth and/or appears to move depending on the visual angle.

The lenticules may be cylindrical, pyramidal, trapezoidal, or parabolic. Lenticular lenses are usually composed of a rigid plastic and are well known and commercially available. Methods for using lenticular lens technology are described in detail in U.S. Pat. Nos. 5,113,213 and 5,266,995, the disclosures of which are incorporated herein by reference.

The underlying interlaced images are a composite of two or more composite interlaced pictures and the lenticular lenses are arranged with the segmented portions to provide the desired image effect. The flat back surface of the lens material may be applied over the interlaced image and the image is viewed through the lenticular lenses. Such lenticular image configurations are shown in U.S. Pat. Nos. 5,488,451; 5,617,178; 5,847,808; and 5,896,230, the disclosures of which are incorporated herein by reference. Early lenticular technology used both the lenticular image and lenticular lenses as separate components. More recently, the lenticular image may be incorporated directly onto the flat back surface of the lenticular sheet or film as taught in U.S. Pat. Nos. 5,457,515 and 6,424,467, the disclosure of which is incorporated herein by reference. A rigid lenticular lens is preferred in order to produce the high quality graphics found in the best three-dimensional and animated effects. Lenticular lenses manufactured from a less rigid material cannot be used with a conventional offset printing press which are used to print high resolution graphics.

It should be understood in the discussion with respect to the present invention that lenticular imaging is distinct from holographic imaging. Holographic imaging utilizes a three-dimensional image that is created using lasers. Because both holographic imagery and lenticular images can display depth, the terms are sometimes confused, but it should be understood that the holographic images and lenticular images are separate and distinct technologies. Holograms are a medium for bending and focusing light that uses the interference of monochromatic object and reference waves to record and reproduce multiple two-dimensional images for three-dimensional viewing. When correctly lit, holograms can produce stunning, albeit monochromatic, effects. In contrast, the lenticular image can portray full color artwork. Additionally, lenticular technology is extremely durable and able to withstand the wear and tear often endured by articles of clothing during wear and wash. Lenticular, in fact, is so durable that is often used for promotional mailers. Whereas a hologram would require a protective outer layer such as described in U.S. Pat. Nos. 5,636,385 and 5,314,767 to prevent scratching and/or delamination, lenticular is scratch resistant and impervious to delamination.

Because of the intense visual characteristics of lenticular graphics, it would be desirable to include such graphics on clothing and soft goods. Presently, T-shirts, fleeces, hats, jackets, sleepwear, and other apparel items, as well as many softgood accessories such as backpacks, lunchsacks, optical disc organizers, duffel bags, 3-ring binders, portfolios, purses, shoes, portable computer cases and the like are produced and sold with non-lenticular graphics attached. Such graphics consist of a variety of different materials such as cloth, rubber, chenille, and even some printed and coated plastics. These graphics are attached using different methods such as heat sealing with hot-tipped cutting tools, heated dies, lasers, or a heated steel rule die. The aforementioned methods cause undesired heat degradation of the material abutting the attached portion. The graphics can also be hot glued or sewn into place.

Radio Frequency (RF) welding is an alternative method of attaching graphic pieces to cloth or soft goods. RF welding has been used for attaching a variety of “soft” plastics fabricated most commonly out of Polyvinylchloride (PVC). RF tooling, unlike other heat sealing methods, uses a “cold” seal. This means that once the RF is turned off, the materials stop being heated but remain under pressure. In this fashion it is possible to quickly heat, weld, and cool the materials under compression. More control over the weld means more control over the melt, the extrusion, and the resulting strength of the seal. However, RF welding has been unusable for attaching rigid plastics in the past, due to their inability to properly attach the rigid material to the cloth surface.

Although each of the aforementioned methods are satisfactory for standard “soft” graphics, the rigid plastic lenses used in lenticular technology are heat sensitive and because they are rigid cannot be easily be sewn onto material. Hot glue poses the same problems of heat degradation, and also creates and undesirable look through the translucent material of the lenticular substrate. As stated, RF welding is not desirable for welding rigid plastic.

Accordingly, there is a need in the art for a method of attaching lenticular lens graphics to apparel and other soft goods without using a heat sealing, gluing or sewing process.

### BRIEF SUMMARY

The present invention comprises novel apparel or softgood items, and methods of manufacture, that comprise a lenticular image attached to a cloth surface. With the recent creation of lenticular graphics formed of PVC, it is now possible to attach lenticluar pieces to cloth using RF welding. In one method of the present invention, an item having a cloth surface is provided. The lenticular image piece is positioned on a desired location of the item. The piece is formed from a polymer that is sufficiently rigid in order to be printed with a high resolution lenticular image, while at the same time is capable of being RF welded. The present invention utilizes a special lenticular lens extruded out of a mixture of polyester resins that were determined to work with the RF welding process. Such a polymer is CAROM 60 PVC produced by GOEX Corp. (Janesville, Wis.). The cloth and lenticular piece are then placed on a RF machine between a platen and the welding die of the RF machine. The welding die includes at least one raised edge operable to weld the piece to the item while also cutting the piece. The machine head containing the welding die is then lowered so as to compress the piece and the cloth between the platen and the welding die. Finally, the machine is activated and RF energy is channeled through the raised edge in order to weld the piece to the item.

The method of manufacture may further include pieces of flexible film placed between the item and the piece and/or on top of the lenticular piece in order to create a more durable bond. The flexible films may be made from certain polymers including nylon, PET, EVA, and ABS resins. More preferably, the flexible films are made from a thermoplastic polymer such as PVC or polyurethane.

Alternatively, the lenticular piece may be attached by a method wherein the flexible film creates a frame around the piece, rather than welding the lenticluar piece to the underlying item. In this method, the item having a cloth surface is provided. Next, a first flexible film is positioned on the item, followed by a die-cut lenticular image, followed by a second flexible film. In this method, the welding die includes two raised welding edges, an inner edge and an outer edge, to create two welds. The lenticular piece is die-cut so that the diameter of the piece is greater than the diameter of the inner edge but less than the diameter of the outer edge. Accordingly, the lenticluar piece itself is not welded to the underlying item; rather, the flexible film is welded to the piece and to the item, thus creating a frame around the lenticular piece. Similarly, the welding die of the first method described above may likewise have inner and outer welding edges. In that case, the lenticular piece would have a diameter greater than both of the welding edges so that the piece is still welded directly to the underlying item.

Additionally, laser guides may be used to aid the positioning of the lenticular piece when a first flexible film is used, whereupon the desired placement location of the piece may be obscured.

Numerous items are capable of being produced using the above methods including, but not limited to, apparel items such as T-shirts, fleeces, hats, jackets, and sleepwear and softgoods such as backpacks, lunchsacks, optical disc organizers, duffel bags, 3-ring binders, shoes, portfolios, purses, and portable computer cases.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1. is a representation of a T-shirt with a lenticular piece applied in accordance with the method of the present invention;

FIG. 2. is an exploded view of the component materials used in the method of attaching a lenticular piece in one embodiment of the invention;

FIG. 3. is a top view of the contact surface of the welding die used in the method of the present invention;

FIG. 4 is a cross-sectional view of the welding die of FIG. 3;

FIG. 5 is a cross-sectional view of the component materials and RF welding die alignment used in one embodiment of the invention;

FIG. 5a is a cross-sectional view of a finished weld formed in accordance of the method of one embodiment of the present invention;

FIG. 6 is a cross-sectional view of the component material and welding die alignment used in another embodiment of the present invention;

FIG. 7 is a top view of the finished weld formed in accordance with the method of another embodiment of the present invention.

FIG. 8 is a cross-sectional view of the finished weld formed in accordance with the method of another embodiment of the present invention.

FIG. 8a is a detailed cross-sectional view of the finished weld formed in accordance with the method of another embodiment of the present invention.

### DETAILED DESCRIPTION

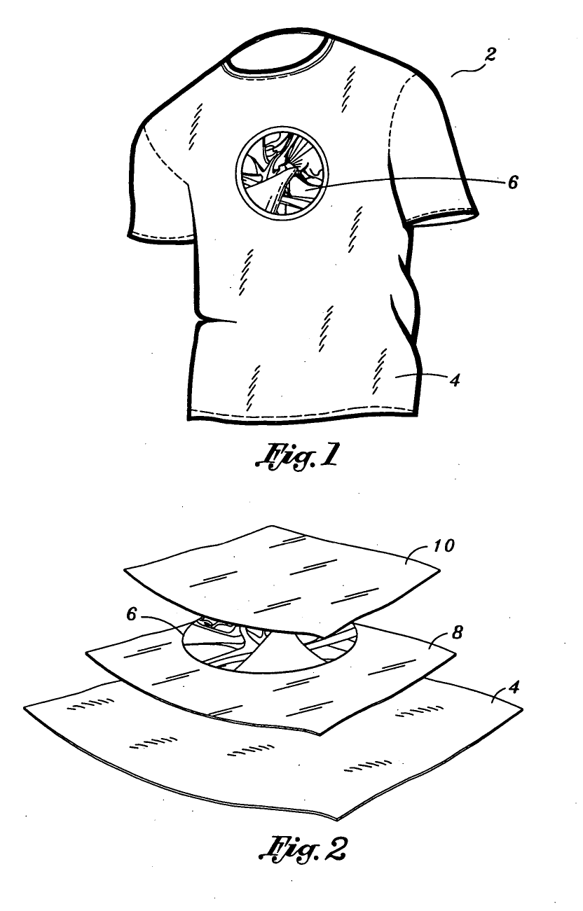

Referring now to the drawings wherein the showings are for the purposes of illustrating the embodiments of the present invention only and not for purposes of limiting the same, FIG. 1 shows a T-shirt 2 produced in accordance with the method of the present invention. The cloth 4 of the T-shirt 2 has a welded lenticular piece 6.

In order to bond the lenticular piece 6 to the cloth 4, a process known as RF welding is used. Sometimes referred to as dielectric sealing, RF welding is much more effective than other processes used in attaching pieces to a cloth. RF welding uses high frequency radio energy to produce molecular agitation in thermoplastic materials, e.g., polyurethane or polyvinylchloride (PVC), to the point where they fuse together and to the substrate they are being bonded to. The typical result is a bond that is as strong as the original thermoplastic material. The lenticular piece 6 may be welded directly to the substrate cloth 4.

One embodiment of the method of the present invention is illustrated in FIG. 2, showing component material. Flexible films 10, 15 placed on top of lenticular piece 6 and film 8 is placed between the piece 6 and cloth 4. The flexible films 8 and 10 may be made of polymer substrates, e.g., nylon, PET, EVA, and ABS resins. In the embodiment shown, the flexible films 8 and 10 are formed of thermoplastic polymers such as PVC or polyurethane. Although two flexible films 8 and 10 are shown, it is contemplated that the weld could be achieved using only one flexible film either 8 or 10, or no flexible film at all.

In the embodiment shown in FIG. 2, the first flexible film 10 is placed on top of the fabric 4. Next, the lenticular piece 6 is placed on top of the first flexible film 2. For this process, laser guides may be projected onto the welding surface to ensure proper placement of the lenticular piece 6 to avoid the accidental welding of the desired image area. After proper placement of the lenticular piece 6 is achieved, a second flexible film 10 is placed on top of the lenticular piece 6. This second flexible film 10 will ultimately act as a finishing border for the lenticular piece 6 after the weld is completed, and additionally, will help to create an even more durable bond.

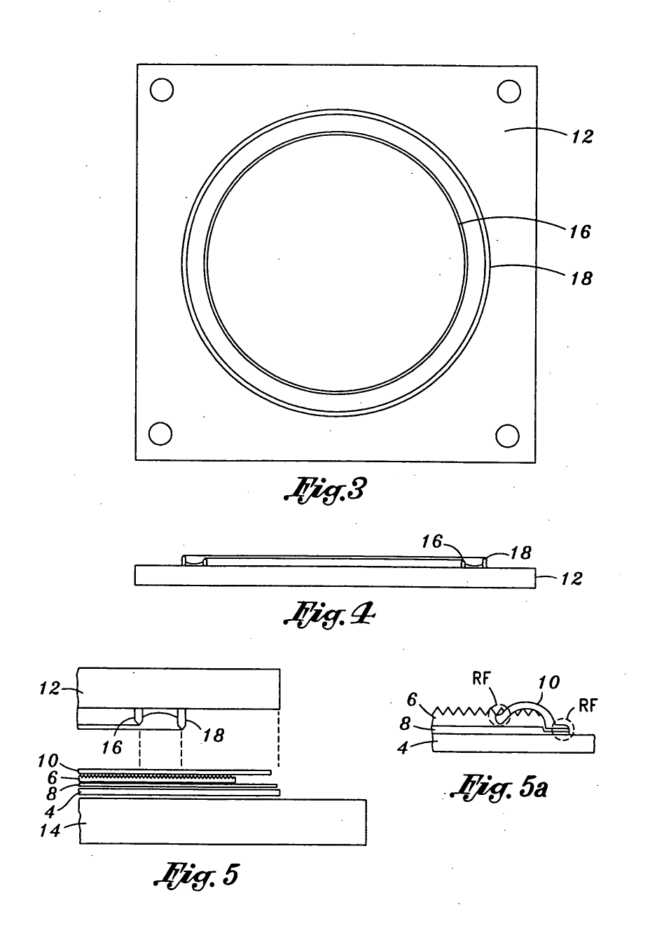

Referring particularly to FIGS. 3,4,5 and 5a, to produce the weld, the substrate 4, first flexible film 8, lenticular piece 6, and second flexible film 10 are placed between a welding die 12 and a platen 14 on the welding table of the RF machine as shown in FIG. 5. Typically a non-conductive layer of material is placed between the platen 14 and the fabric layer 4 to avoid RF energy directly contacting the platen 14. This prevents the potential of a welding arc. The non-conductive material is preferably fiberboard or other like material. The welding die 12, as shown in FIGS. 3 and 4, is usually manufactured out of steel, brass, or aluminum. The welding die 12 contains at least one raised edge representing the area to be welded and cut. If only a single edge is used, the upper peripheral welding surface of that edge may be made wider in order to increase the width and strength of the weld. The method of the present invention, includes at least two edges so that the rigid lenticular piece 6 has at least two weld lines creating a more secure bond. The embodiment illustrated in FIGS. 3 and 4 includes an inner raised edge 16 and an outer raised edge 18.

When the RF machine is activated, the head of the machine, which holds the welding die 12, is lowered and generates pressure on the materials 4, 8, 6, and 10 positioned on the platen 14. Then the RF is turned on and is channeled through the materials 4, 8, 6 and 10 in the pattern of the raised edges 16 and 18. The edges 16 and 18 of the welding die 12 act to weld the polymer materials 8, 6 and 10 to the cloth substrate 4. This weld occurs as the high frequency current heats and liquifies the polymer materials 8, 6 and 10 whereupon the pressure exerted by the welding die 12 brings about a thorough fusion. Next, the RF is turned off, allowing for the polymer materials 8, 6 and 10 to cool and solidify, thus completing the seal with the cloth 4. The raised edges 16 and 18, which have been placed at predetermined heights, exert enough pressure to weld and cut the polymer material 8, 6 and 10 so that after the welding process is complete and the material has been allowed to cool the excess material can be torn away. After cooling, the second flexible film material 10 that lies inside the inner raised edge 16 and the polymer material 8 and 6 outside the outer raised edge 18 can be torn away leaving the finished lenticular piece 6 welded permanently and attractively to the cloth 4, as shown in FIG. 5a.

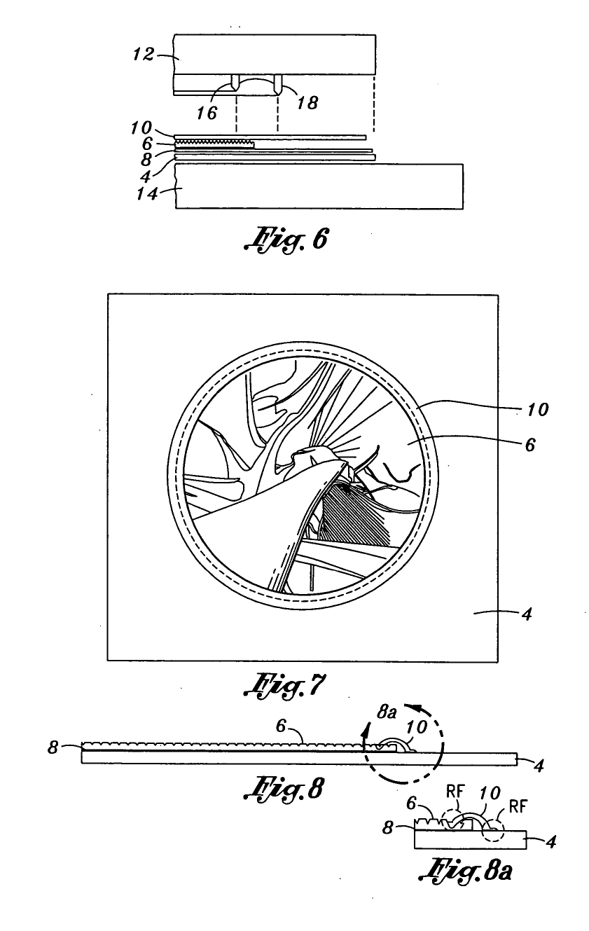

Referring particularly to FIGS. 6, 7, 8 and 8a another embodiment of the method of the present invention wherein, a die-cut lenticular piece 6 may be attached using the RF welding process of the present invention in a way that the piece 6 is not welded directly to the cloth substrate 4, as in the above mentioned embodiment, but rather is framed using flexible films 8 and 10. In order to achieve such a frame weld, the lenticular piece 6 is die-cut to a predetermined size so that the diameter of its outer peripheral edge is slightly greater than the diameter of the inner raised edge 16, but less than the diameter of the outer raised edge 18, as shown in FIG. 6. The predetermined variance between these three measurements allows for a gap to be formed between the inner raised edge 16 and outer raised edge 18, thus creating a frame for the lenticular piece 6 as can be seen in FIG. 7. This frame is created by welding the second flexible film 10 to the upper linear surface of the die-cut lenticular piece 6 just inside its outer peripheral edge. At the same time, the second flexible film 10 is welded to the first flexible film 8 and the cloth 4 just outside the outer peripheral edge of the die-cut lenticular piece 6. Once the weld is completed, the excess second flexible film material 10 that lies inside the inner raised edge 16 and the flexible film material 8 and 10 outside the outer raised edge 18 can then be removed, leaving the lenticular piece 6 attached to the cloth 4 via a frame as shown in FIGS. 8 and 8a.

The above description is given by way of example, and not limitation. Given the above disclosure, one skilled in the art could devise variations that are within the scope and spirit of the invention disclosed herein, including engraving or profiling the welding die 12 in order to add decorative aesthetics to the upper surface of the lenticular piece 6 and/or the second flexible film 10. Also, the lenticular pieces may optionally be combined with other decorative effects, e.g., silk screening, embroidery, heat transferred images, and/or dye-sublimation. Further, the various features of the embodiments disclosed herein can be used alone, or in varying combinations with each other and are not intended to be limited to the specific combination described herein. Thus, the scope of the claims is not to be limited by the illustrated embodiments. Although the detailed description refers to cloth 4, the cloth 4 can be any material used in clothing or soft goods such as, but not limited to, nylon, fabric, canvas, cotton or other flexible material.

What is claimed is:

1. A method of attaching a lenticular piece to a fabric surface comprising the steps of:
providing a fabric surface for receiving a lenticuar substrate;
providing a lenticular substrate having generally planar top and bottom surfaces, said top surface having a plurality of lenticules and said bottom surface having an image;
positioning the bottom surface of the lenticular substrate against the fabric surface;
compressing the lenticular substrate and fabric surface between upper and lower metal surfaces; and
channeling RF energy through the die surface to fuse at least a portion of the lenticular substrate to the fabric surface.

2. The method of claim 1 wherein said lenticular substrate is formed from an RF weldable PVC.

3. The method of claim 1 wherein said upper metal surface has at least one raised surface.

4. The method of claim 3 wherein said raised surface channels the RF energy to an area on said lenticular substrate to be fused to said fabric surface.

5. The method of claim 3 wherein the upper metal surface is a welding die.

6. The method of claim 3 wherein the lower metal surface is a platen.

7. The method of claim 3 wherein the upper surface is a welding die and the lower surface is a platen, both of which are components of an RF welding machine.

8. The method of claim 3 wherein said raised surface includes raised perimeter defining an inner non-raised surface, and an outer surface.

9. The method of claim 8 wherein said outer surface defines a second raised surface including a raised perimeter enclosing the perimeter of the inner non-raised surface.

10. The method of claim 1, wherein laser guides are used to aid positioning the lenticular piece upon the fabric surface.

11. An item of apparel having a lenticular piece, said item produced by the method of claim 1.

12. A method of attaching a lenticular piece to a fabric surface comprising the steps of:
providing a fabric surface for attaching lenticular artwork;
placing a first flexible film on the fabric surface;
providing a lenticular substrate having generally planar top and bottom surfaces, said top surface having a plurality of lenticules and said bottom surface having an image;
positioning the bottom surface of the lenticular substrate against the first flexible film;
positioning a second flexible film against the top surface of said lenticular substrate;
compressing the second flexible film, lenticular substrate, first flexible film and fabric surface between upper and lower metal surfaces; and
channeling RF energy through the die surface to fuse at least a portion of the the first and second flexible films and lenticular substrate to the fabric surface.

13. The method of claim 12 wherein said lenticular substrate is formed from an RF weldable PVC.

14. The method of claim 12 wherein said upper metal surface has at least one raised surface.

15. The method of claim 14 wherein said raised surface channels the RF energy to an area on said second flexible film, lenticular substrate and first flexible film to be fused to said fabric surface.

16. The method of claim 14 wherein the upper metal surface is a welding die.

17. The method of claim 14 wherein the lower metal surface is a platen.

18. The method of claim 14 wherein the upper surface is a welding die and the lower surface is a platen, both of which are components of an RF welding machine.

19. The method of claim 14 wherein said raised surface includes raised perimeter defining an inner non-raised surface, and an outer surface.

20. The method of claim 19 wherein said outer surface defines a second raised surface including a raised perimeter enclosing the perimeter of the inner non-raised surface.

21. The method of claim 20 where in the perimeter of the lenticular substrate is greater than the inner-non raised surface.

22. The method of claim 21 wherein the perimeter of the lenticular substrate lies within the second raised surface.

23. The method of claim 22 wherein the a first weld is created on said lentiuclar substrate, and a second weld is created outside the perimeter of the lenticular substrate.

24. The method of claim 12, wherein laser guides are used to aid positioning the lenticular piece upon the fabric surface.

25. The method of claim 12, wherein the first and second flexible films are made from polymers selected from the group consisting of nylon, PET, EVA, and ABS resins.

26. An item of apparel having a lenticular piece, said item produced by the method of claim 12.

27. A method of attaching a lenticular piece to a fabric surface comprising the steps of:
providing a fabric surface for attaching lenticular artwork;
placing a flexible film on the fabric surface;
providing a lenticular substrate having generally planar top and bottom surfaces, said top surface having a plurality of lenticules and said bottom surface having an image;
positioning the bottom surface of the lenticular substrate against the first flexible film;
compressing the, lenticular substrate, flexible film and fabric surface between upper and lower metal surfaces; and
channeling RF energy through the die surface to fuse at least a portion of the the first and second flexible films and lenticular substrate to the fabric surface.

28. The method of claim 26, wherein the flexible film is made from polymers selected from the group consisting of nylon, PET, EVA, and ABS resins.

29. An item of apparel having a lenticular piece, said item produced by the method of claim 26.

30. A method of attaching a lenticular piece to a fabric surface comprising the steps of:
providing a fabric surface for attaching lenticular artwork;
providing a lenticular substrate having generally planar top and bottom surfaces, said top surface having a plurality of lenticules and said bottom surface having an image;
positioning the bottom surface of the lenticular substrate against the fabric surface;
positioning a flexible film against the top surface of said lenticular substrate
compressing the flexible film, lenticular substrate and fabric surface between upper and lower metal surfaces; and
channeling RF energy through the die surface to fuse at least a portion of the the first and second flexible films and lenticular substrate to the fabric surface.

31. The method of claim 29, wherein the flexible films are made from polymers selected from the group consisting of nylon, PET, EVA, and ABS resins.

32. An item of apparel having a lenticular piece, said item produced by the method of claim 29.

33. A method of attaching a lenticular image piece to a substrate, the method comprising the steps of:
providing a substrate fabric surface;
positioning the lenticular piece on a desired location of the substate surface wherein the piece is made of an RF-weldable rigid polymer;
placing the substrate and lenticular piece between a platen and welding die of an RF machine, wherein the welding die includes at least one raised welding edge;
compressing the substrate and lenticluar piece between the platen and the welding die; and
welding the piece to the substrate by activating and channeling the RF energy through the raised welding edge.

34. The method of claim 32, wherein the flexible films are made from polymers selected from the group consisting of nylon, PET, EVA, and ABS resins.

35. The method of claim 32, wherein the flexible films are thermoplastic polymers selected from the group consisting of PVC and polyurethane.

36. The method of claim 32, wherein laser guides are used to aid positioning the lenticular piece.

37. The method of claim 32, wherein the welding die comprises an inner raised welding edge and an outer raised welding edge.

38. The method of claim 32, wherein the substrate is an apparel item.

39. The method of claim 32 wherein the apparel item is selected from the group consisting of T-shirts, fleece, hats, jackets, shoes and sleepwear.

40. The method of claim 32, wherein the substrate is a softgood accessory selected from the group consisting of backpacks, lunchsacks, optical disc organizers, duffel bags, 3-ring binders, portfolios, purses, and portable computer cases.

41. An item of apparel having a lenticular piece, said item produced by the method of claim 32.

42. A method of attaching a die-cut lenticular image piece to a substrate, the method comprising the steps of:
providing a substrate having a fabric surface;
positioning a first flexible film on a desired location of the substrate;
positioning the die-cut lenticular image piece on the first flexible film, wherein the piece is made of an RF-weldable rigid polymer;
positioning a second flexible film on the piece;
placing the substrate, flexible films, and piece between a platen and welding die of an RF machine, wherein the welding die includes an inner raised welding edge and an outer raised welding edge, and wherein the diameter of the die-cut piece is greater than the diameter of the inner raised welding edge but less than the diameter of the outer raised welding edge;
compressing the substrate and piece between the platen and the welding die; and
welding the piece to the substrate by activating and channeling the RF energy through the raised welding edge.

43. An item of apparel having a lenticular piece, said item produced by the method of claim 41.
